(19) United States
(12) Patent Application Publication
(10) Pub. No.: US 2008/0013624 A1
(43) Pub. Date: Jan. 17, 2008

(54) METHOD AND APPARATUS FOR ENCODING AND DECODING VIDEO SIGNAL OF FGS LAYER BY REORDERING TRANSFORM COEFFICIENTS

(75) Inventor: Woo-jin HAN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/777,563

(22) Filed: Jul. 13, 2007

Related U.S. Application Data
(60) Provisional application No. 60/830,603, filed on Jul. 14, 2006.

(30) Foreign Application Priority Data
Oct. 19, 2006 (KR) 10-2006-0102067

(51) Int. Cl. H04B 1/66; H04N 11/04

(52) U.S. Cl. 375/240.1; 375/240.18

(57) ABSTRACT

A method of encoding a video signal of an FGS layer by reordering transform coefficients includes classifying transform coefficients of blocks in a current layer to be encoded into significant coefficients and refinement coefficients, reordering the significant coefficients and the refinement coefficients according to the classifications, and coding the reordered significant coefficients and refinement coefficients.

### CROSS REFERENCE TO RELATED APPLICATION

This application claims priority from U.S. Provisional Patent Application No. 60/830,603 filed on Jul. 14, 2006 in the USPTO and Korean Patent Application No. 10-2006-0102067 filed on Oct. 19, 2006 in the Korean Intellectual Property Office, the disclosures of which are incorporated herein by reference in their entirety.

### BACKGROUND OF THE INVENTION

1. Field of the Invention

The present invention relates to a video compression technology, and in particular, to a method and apparatus for encoding and decoding a video signal of an FGS layer by reordering transform coefficients in H.264 scalable video coding (SVC).

2. Description of the Related Art

With the development of an information communication technology including the Internet, multimedia services including various types of information, such as characters, images, or music, are increasing. Multimedia data is mass data, and thus it requires large-volume storage mediums and wide bandwidths upon transmission. Accordingly, in order to transmit multimedia data including characters, images, and audio, the use of a compression coding technology is essential.

The fundamental principle of data compression is to eliminate redundancy in data. Data compression can be achieved by eliminating spatial redundancy, such as the repetition of a color or object in an image, temporal redundancy, such as temporally neighboring motion picture frames with little change or redundant audio sound, psychovisual redundancy that takes into account a human's visual and perceptual insensitivity to high frequencies. Types of data compression are divided into lossy/lossless compression, intra-frame/inter-frame compression, and symmetric/asymmetric compression according to whether or not source data is lost, whether or not individual frames are independently compressed, and whether or not a time for compression is consistent with a time for decompression, respectively. Meanwhile, in a general video coding method, temporal redundancy is eliminated using temporal filtering based on motion compensation, and spatial redundancy is eliminated using a spatial transform.

In order to transmit multimedia data to be generated after data redundancy is eliminated, transmission mediums are required. Performance varies according to the transmission mediums. Currently used transmission mediums have various transmission speeds ranging from the speed of an ultra high-speed communication network, through which data can be transmitted at a transmission rate of several tens of megabits per second, to the speed of a mobile communication network, through which data can be transmitted at a transmission rate of 384 kbits per second. In this situation, a so-called scalable video coding (SVC) method is required that can support the transmission mediums having various speeds and that can transmit multimedia at a transmission rate suitable for each transmission environment.

Such a scalable video coding method broadly refers to a coding method including spatial scalability, in which video resolution can be adjusted, SNR (Signal-to-Noise Ratio) scalability, in which video quality can be adjusted, temporal scalability, in which a frame rate can be adjusted, and a combination thereof

In regard to such a scalable video coding method, standardization is in progress by MPEG-4 (Moving Picture Experts Group-21) Part 10. Considerable research has been performed to implement multilayer based scalability among them. For example, when a multilayer has a base layer, a first enhanced layer, a second enhanced layer, and the like, the individual layers may have different resolution (QCIF, CIF, 2CIF, and the like) or may have different frame rates.

Like a case where coding is performed for one layer, when coding is performed for multiple layers, in order to eliminate temporal redundancy, it is necessary to obtain a motion vector (MV) for each layer. As the motion vector, motion vectors that are separately retrieved for the individual layers may be used or a motion vector that is retrieved for one layer may be used for other layers as it is or through up/down sampling.

FIG. 1 is a diagram showing a scalable video codec using a multilayer structure. First, the base layer is defined as QCIF (Quarter Common Intermediate Format)_{—}15 Hz (frame rate), the first enhanced layer is defined as CIF (Common Intermediate Format)_{—}30 Hz, and a second enhanced layer is defined as SD (Standard Definition)_{—}60 Hz. If a CIF 0.5 Mbps stream is desired, a bit stream may be truncated and transmitted such that a bit rate at CIF_{—}30 Hz_{—}0.7 Mbps in the first enhanced layer becomes 0.5 Mbps. In such a manner, spatial and temporal SNR scalability can be implemented.

As shown in FIG. 1, frames (for example, 10, 20, and 30) in the individual layers having the same temporal positions can be estimated to have similar images. Accordingly, there is known a method that predicts a texture of a current layer from a texture of a lower layer directly or through up-sampling, and encodes a difference between the predicted value and the texture of the current layer. In “Scalable Video Model 3.0 of ISO/IEC 21000-13 Scalable Video Coding” (hereinafter, referred to as “SVM 3.0”), the above method is defined as Intra BL prediction.

As such, in SVM 3.0, in addition to “inter prediction” and “directional intra prediction” that are used to predict blocks constituting a current frame and a macro block in the existing H.264, a method that predicts a current block using correlation between the current block and a corresponding block of the lower layer is additionally adopted. This prediction method is called “intra BL prediction”. Further, a mode that is encoded using this prediction method is called “intra BL mode”.

FIG. 2 is a schematic view illustrating the above-described three prediction methods. FIG. 2 shows the intra prediction for a macro block 14 of a current frame 11 (\hat{1}), the inter prediction using a macro block 15 of a frame 12 located at a temporal position different from the current frame 11 (\hat{2}), and the intra BL prediction using texture data for a region 16 of a base layer frame 13 corresponding to the macro block 14. As such, in the scalable video coding standard, one of the three prediction methods is selected and used in the macro blocks.

Meanwhile, in a current coding method of an FGS layer, compression is performed after transform coefficients of blocks in the current layer to be compressed are divided into significant coefficients and refinement coefficients. At this time, since different coding methods are applied to the significant coefficients and the refinement coefficients, parsing of the bit streams of the blocks in the current layer depends on the lower layer corresponding to the current layer. Accordingly, parsing is performed from the lower layer to the upper layer. This causes deterioration of compression performance and an increase in computational complexity.

Accordingly, a method and apparatus for performing independent parsing of upper layers before the lower layers, which are not referred to, in a structure having FGS layers is needed.

### SUMMARY OF THE INVENTION

The invention has been finalized in order to address the above problems, and it is an aspect of the invention to provide a method and apparatus for encoding and decoding a video signal of an FGS layer by reordering transform coefficients that enables independent parsing in a structure having a plurality of FGS layers, thereby reducing computational complexity.

Aspects of the invention are not limited to that mentioned above, and other aspects of the invention will be understood by those skilled in the art through the following description.

According to an aspect of the invention, there is provided a method of encoding a video signal of an FGS layer by reordering transform coefficients, the method including classifying transform coefficients of blocks in a current layer to be encoded into significant coefficients and refinement coefficients, reordering the significant coefficients and the refinement coefficients according to the classifications, and coding the reordered significant coefficients and refinement coefficients.

According to another aspect of the invention, there is provided a method of decoding a video signal of an FGS layer by reordering transform coefficients, the method including parsing bit streams of a current layer to be decoded so as to extract transform coefficients, inverse-ordering the extracted transform coefficients in an original sequence with reference to transform coefficients of blocks in a lower layer, and decoding the inverse-ordered transform coefficients.

According to still another aspect of the invention, there is provided an apparatus for encoding a video signal of an FGS layer by reordering transform coefficients, the apparatus including a transform coefficient classification unit classifying transform coefficients of blocks in a current layer to be encoded into significant coefficients and refinement coefficients, a reordering unit reordering the significant coefficients and the refinement coefficients according to the classifications, and a coefficient coding unit coding the reordered significant coefficients and refinement coefficients.

According to yet still another aspect of the invention, there is provided an apparatus for decoding a video signal of an FGS layer by reordering transform coefficients, the apparatus including a transform coefficient extraction unit parsing bit streams in a current layer to be decoded so as to extract transform coefficients, an inverse-ordering unit inverse-ordering the extracted transform coefficients in an original sequence with reference to transform coefficients of blocks in a lower layer, and a coefficient decoding unit decoding the inverse-ordered transform coefficient.

### BRIEF DESCRIPTION OF THE DRAWINGS

The above and other features and advantages of the invention will become more apparent by describing in detail exemplary embodiments thereof with reference to the attached drawings in which:

FIG. 1 is a diagram showing a scalable video codec using a multilayer structure;

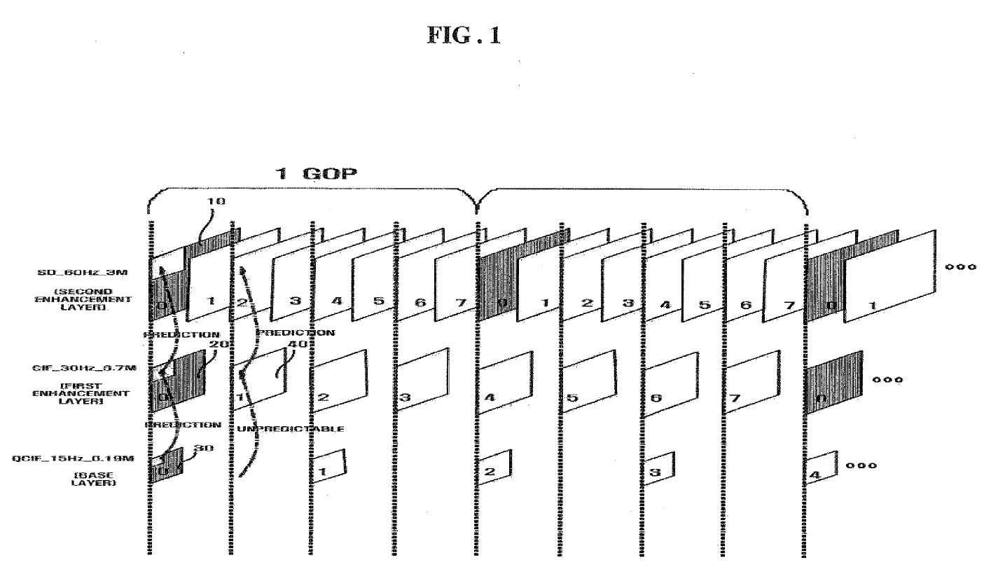

FIG. 2 is a diagram illustrating three prediction methods in the scalable video codec;

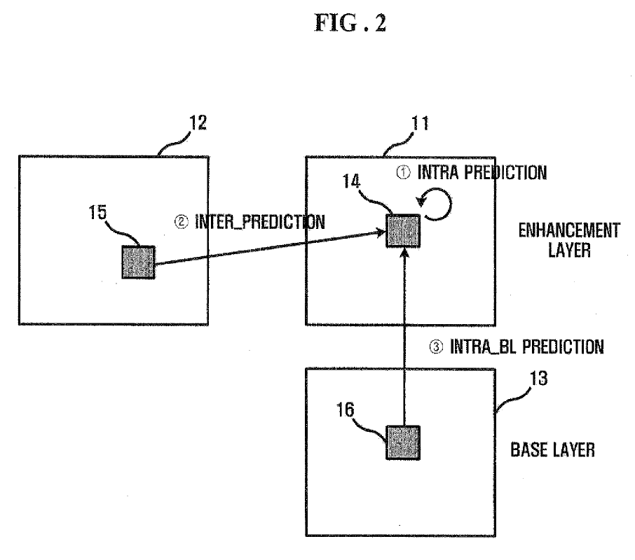

FIG. 3 is a diagram showing a structure having a base layer and a plurality of FGS layers;

FIG. 4A is a diagram showing a process of classifying transform coefficients of the current layer in an FGS coding pass;

FIG. 4B is a diagram showing a process of determining a scanning sequence for the transform coefficients of the current layer according to the result of FIG. 4A;

FIG. 5 is a diagram showing a process of encoding and decoding a video signal of an FGS layer by reordering transform coefficients according to an exemplary embodiment of the invention;

FIG. 6 is a flowchart showing a process of encoding a video signal of an FGS layer by reordering transform coefficients according to an exemplary embodiment of the invention;

FIG. 7 is a flowchart showing a process of decoding a video signal of an FGS layer by reordering transform coefficients according to an exemplary embodiment of the invention;

FIG. 8 is a block diagram of an apparatus for encoding a video signal of an FGS layer by reordering transform coefficients according to an exemplary embodiment of the invention; and

FIG. 9 is a block diagram of an apparatus for decoding a video signal of an FGS layer by reordering transform coefficients according to an exemplary embodiment of the invention.

### DESCRIPTION OF EXEMPLARY EMBODIMENTS

Advantages and features of the invention and methods of accomplishing the same may be understood more readily by reference to the following detailed description of exemplary embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

Hereinafter, a method and apparatus for encoding/decoding a video signal of an FGS layer by reordering transform coefficients according to an exemplary embodiment of the invention will be described in detail with reference to block diagrams or flowcharts.

A lower layer used herein means a video sequence that has a frame rate lower than the maximum frame rate of a bit stream to be actually generated in a scalable video encoder and has resolution lower than the maximum resolution of the bit stream. As such, what is necessary is that the lower layer has a predetermined frame rate lower than the maximum frame rate and predetermined resolution lower than the maximum resolution. The lower layer does not necessarily have the minimum frame rate and minimum resolution of the bit stream. Hereinafter, a description will be given laying emphasis on a macro block. However, the invention is not limited to the macro block. The invention can be applied to slices or frames, in addition to the macro block.

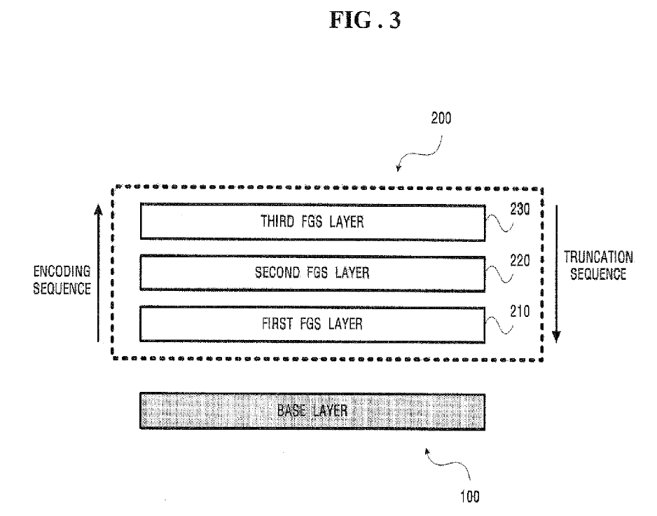

FIG. 3 is a diagram showing a structure having a base layer and a plurality of FGS layers. Referring to FIG. 3, the structure is divided into a base layer 100 and an FGS layer 200, and the FGS layer 200 is divided into a plurality of layers. In FIG. 3, for convenience, three layers 210, 220, and 230 are shown. This structure is a structure that supports SNR scalability. The SNR scalability is a technology that can gradually adjust image quality without using a complex decoding process. In the MPEG-4 and the H.264 SVC that is being standardized, the SNR scalability is supported, which is called FGS (fine grain scalability).

In the H.264 SVC, it can be seen that a plurality of FGS layers are continuously stacked and then encoded according to the feature capable of supporting a plurality of layers. Encoding starts with the base layer 100, and is then performed in a sequence of the first FGS layer 210, the second FGS layer 220, and the third FGS layer 230 in the FGS layer 200. Encoding of an upper layer corresponding to the lower layer is performed with reference to the previously encoded lower layer. Meanwhile, a truncation process of eliminating a part of a bit stream is performed opposite to the coding sequence. That is, the truncation process is performed downward from the uppermost layer (in FIG. 3, the third FGS layer).

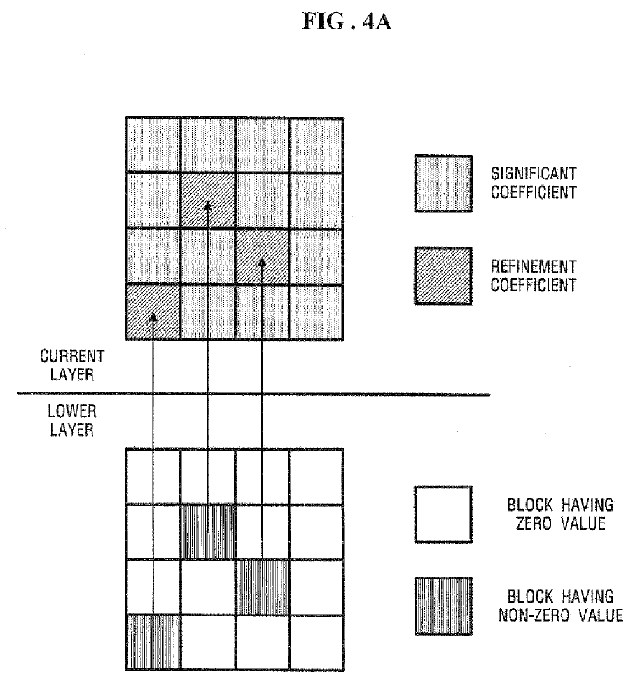

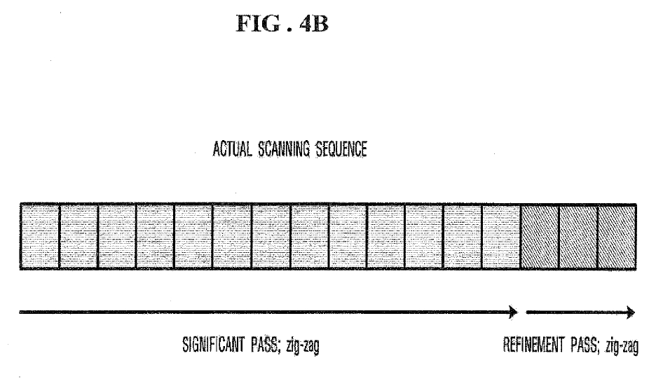

FIG. 4A is a diagram showing a process of classifying transform coefficients of the current layer in an FGS coding pass.

In a coding method of an FGS layer that is currently described in the H.264 SVC working draft, in order to encode transform coefficients in a current layer, the transform coefficients are broadly divided into significant coefficients and refinement coefficients according to whether or not the value of each transform coefficient of the lower layer corresponding to the current layer is zero. That is, when the value of the transform coefficient of the lower layer is zero, the transform coefficients of blocks in the current layer corresponding to the lower layer are classified as the significant coefficients. Further, when the value of the transform coefficient of the lower layer is not zero, the transform coefficients of blocks in the current layer are classified as the refinement coefficients. The classified transform coefficients are transmitted through a subsequent scanning process. This will be described below with reference to FIG. 4B.

FIG. 4B is a diagram showing a process of determining a scanning sequence for the transform coefficients of the current layer according to the result of FIG. 4A. According to a current scanning method, a significant pass in which the significant coefficients are scanned in a diagonally zigzag direction is followed by a refinement pass in which the refinement coefficients are scanned. Although the coefficients are arranged in a line in FIG. 4B, a scanning process is actually performed in a diagonally zigzag direction. In the bit stream, the significant coefficients of the two types of coefficients are located in front of the refinement coefficients. Accordingly, in a truncation process of reducing the size of the bit stream, the refinement coefficients are first truncated.

According to a current coding method after a transform process for the FGS layer, first, the transform coefficients of the blocks in an FGS layer to be compressed are classified into the significant coefficients and the refinement coefficients. Then, the significant coefficients and the refinement coefficients are sequentially encoded.

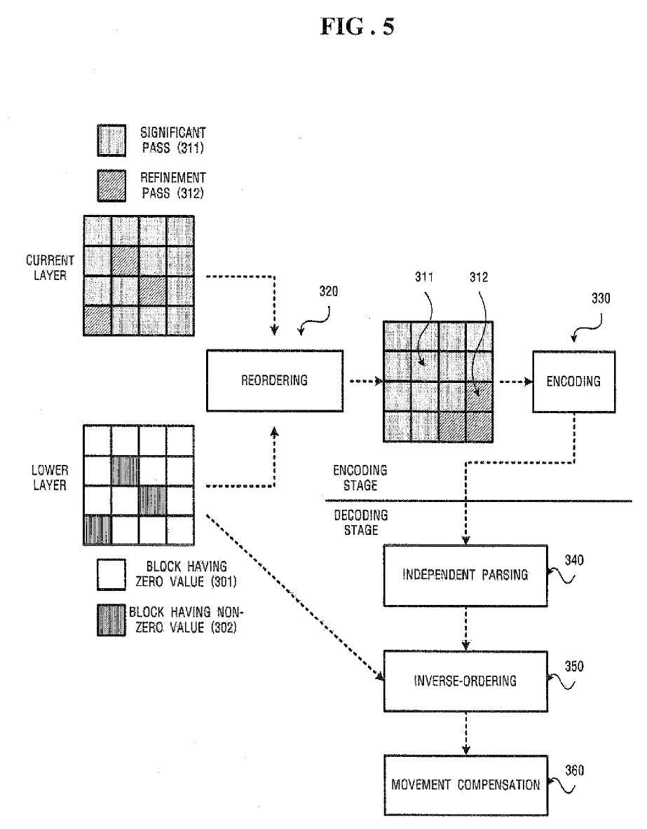

Since different coding methods are applied to the significant coefficients and the refinement coefficients, parsing of the bit streams of the blocks in the current layer depends on the lower layer corresponding to the current layer. Then, a decoder can perform parsing of the bit streams of the current layer only after parsing of the bit streams of the blocks in the lower layer is completed and the transform coefficients are acquired. This limitation means that, in an FGS layer structure having a plurality of layers, parsing should be necessarily performed from the lower layer to the upper layer. This causes an increase in computational complexity, which in turn results in degradation in compression performance. Accordingly, a method of performing independent parsing of blocks of a plurality of layers is needed. This method will be described below with reference to FIG. 5.

FIG. 5 is a diagram showing a process of encoding and decoding a video signal of an FGS layer by reordering transform coefficients according to an embodiment of the invention.

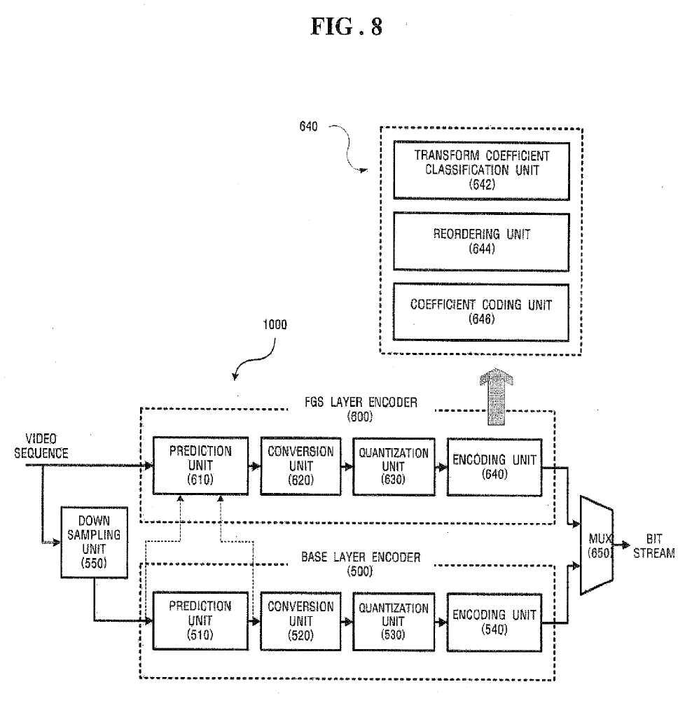

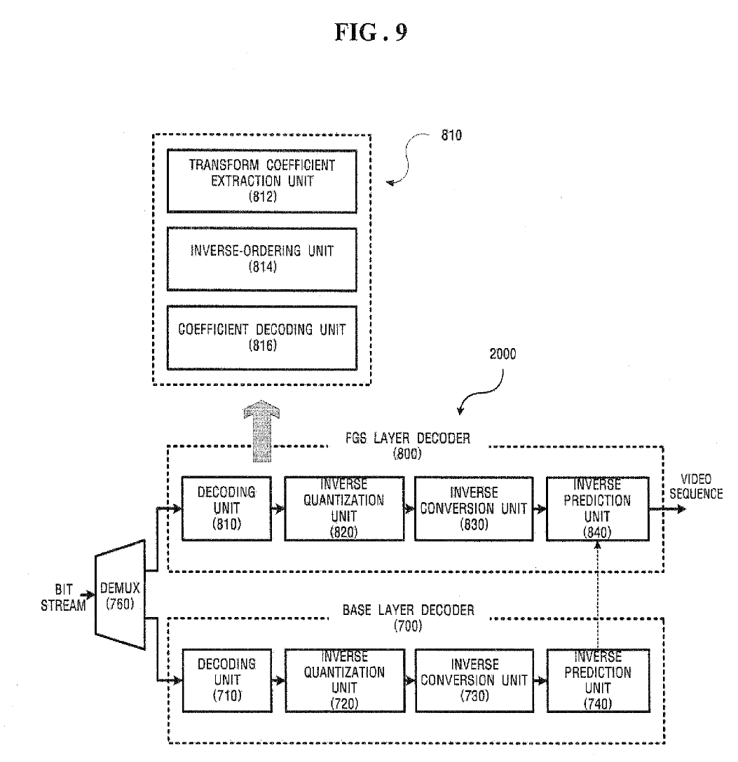

A process of FIG. 5 shows a process of coding transform coefficients after a prediction process, a transform process, and a quantization process in a general coding process of an FGS layer. The prediction process, the transform process, and the quantization process will be simply described below with reference to FIGS. 8 and 9. Here, only the process of coding transform coefficients will be described.

First, the transform coefficients 311 and 312 of the blocks in the current layer to be encoded are classified into the significant coefficients 311 and the refinement coefficients 312. A process of classifying the coefficients is performed as described with reference to FIG. 4A. That is, when the blocks in the lower layer corresponding to the current layer are blocks 301 having zero values, the transform coefficients of the blocks in the current layer corresponding to the blocks 301 are classified as the significant coefficients 311. Further, when the blocks in the lower layer are blocks 302 having non-zero values, the transform coefficients of the blocks in the current layer corresponding to the blocks 302 are classified as the refinement coefficients 312.

After the classification process is completed, a reordering process 320 of ordering the significant coefficients and the refinement coefficients again is performed. As an example of the reordering process 320, there is a method that first orders the significant coefficients 311 and then orders the remaining refinement coefficients 312 to be connected to one another. In general, since the significant coefficients have a greater effect on image quality than the refinement coefficients have, it is preferable to scan the significant coefficients first. Of course, as another example of the reordering process 320, the refinement coefficients 312 may be first ordered, and then the remaining significant coefficients 311 may be ordered to be connected to one another.

The reordering method of FIG. 5 collectively scans the same type of coefficients, thereby improving scanning efficiency, compared with an existing scanning method in a zigzag direction shown in FIG. 4B. That is, with the classification of the transform coefficients into the significant coefficients 311 and the refinement coefficients 312 and reordering, performance of the truncation process of eliminating a part of the bit stream can be improved.

After the reordering process, a coding process 330 of coding the significant coefficients and the refinement coefficients is performed. In this case, the significant coefficients and the refinement coefficients are encoded using the same coding method as the existing coding method of the significant coefficients. Since the same coding method is applied to all the coefficients, independent parsing in decoding becomes possible.

Meanwhile, as a technology that can be used in the coding process 330, CAVLC (Context-Adaptive Variable Length Coding), CABAC (Context-Adaptive Binary Arithmetic Coding), and Exp_Golomb (exponential Golomb) currently used in the H.264 standard can be exemplified. In particular, context-based adaptive variable length coding (CAVLC) is variable length coding that uses information about the last coded neighboring blocks. In this case, variable length coding is performed by selecting one of a plurality coding reference tables according to neighboring blocks of a block to be currently coded.

As described above, after the processes at an encoding stage are performed, the bit stream is received at a decoding stage and decoding is performed. First, parsing of the bit stream in the current layer is performed and the transform coefficients are extracted. In this case, independent parsing 340 that independently parses the bit streams in the current layer without reference to the lower layer corresponding to the current layer is performed. This is because the same coding method is applied to all the transform coefficients at the encoding stage. If independent parsing is performed on a plurality of layers without depending on the lower layer, computational complexity can be significantly reduced in a multi-processor environment. In addition, the upper layer can be first parsed without parsing or decoding the lower layer, which is not referred to, and thus additional computational complexity can be reduced.

After the transform coefficients are extracted through the independent parsing process 340, an inverse ordering process 350 that orders the extracted transform coefficients in an original sequence with reference to the blocks in the lower layer at the encoding stage is performed. When, at the encoding stage, the significant coefficients are first ordered and then the refinement coefficients are ordered, at the decoding stage, the significant coefficients are first filled and then the refinement coefficients are filled. If the refinement coefficients are first ordered at the encoding stage, at the decoding stage, the refinement coefficients are first filled and then the significant coefficients are filled.

After the transform coefficients returns to original positions through the inverse ordering process 350, like the related art, decoding is performed through a motion compensation process 360 and the like. In this case, decoding will be performed from the lower layer to the current layer.

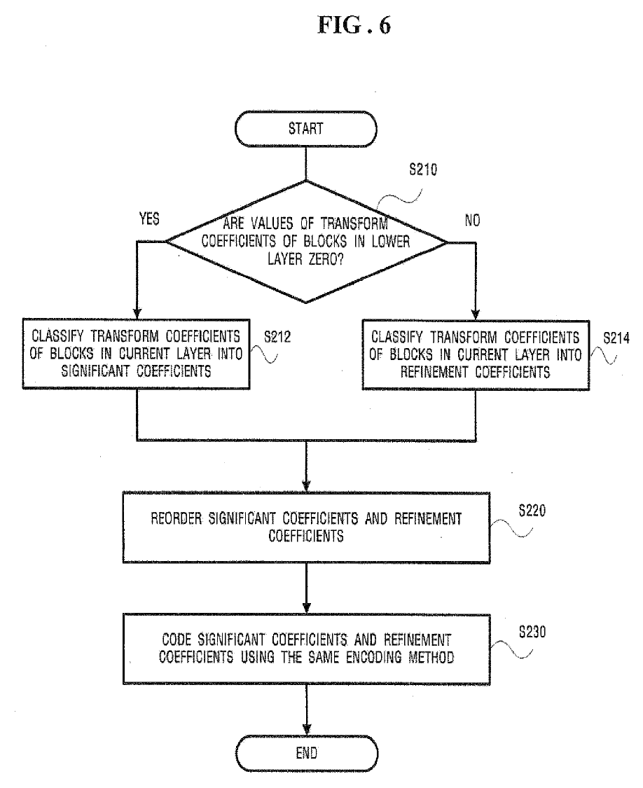

FIG. 6 is a flowchart showing a process of encoding a video signal of an FGS layer by reordering transform coefficients according to an embodiment of the invention. First, it is judged whether or not the transform coefficients of the blocks in the lower layer corresponding to the current layer are zero (S210). If the transform coefficients are zero, the transform coefficients of the blocks in the current layer are classified as the significant coefficients (S212). Meanwhile, if the transform coefficients are not zero, the transform coefficients are classified as the refinement coefficients (S214). According to the classification results, the significant coefficients and the refinement coefficients are reordered (S220), and the reordered significant coefficient and refinement coefficients are coded using the same coding method (S230).

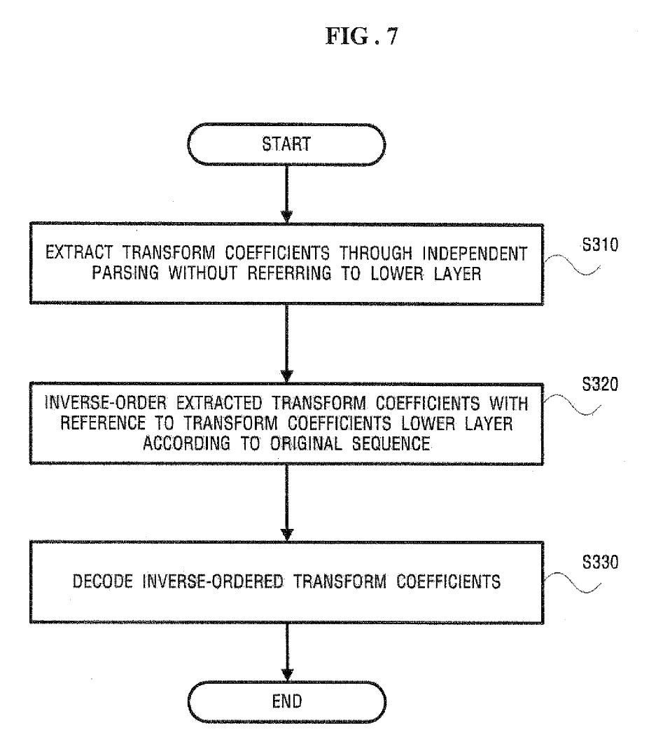

FIG. 7 is a flowchart showing a process of decoding a video signal of an FGS layer by reordering transform coefficients according to an embodiment of the invention. First, the bit streams in the current layer to be decoded are parsed and the transform coefficients are extracted (S310). Subsequently, the extracted transform coefficients are inverse-ordered in the original sequence with reference to the transform coefficients of the blocks in the lower layer (S320). Finally, the inverse-ordered transform coefficients are decoded using the known method (S330).

FIG. 8 is a block diagram of an apparatus for encoding a video signal of an FGS layer by reordering transform coefficients according to an embodiment of the invention.

An original video sequence is input to an FGS layer encoder 600, then subject to down-sampling by a down sampling unit 550 (only when a change in resolution between layers occurs), and subsequently input to a base layer encoder 500.

A prediction unit 610 subtracts an image predicted according to a predetermined method from the current macro block so as to calculate a residual signal. The prediction method includes directional intra prediction, inter prediction, intra base prediction, and residual prediction.

A transform unit 620 transforms the calculated residual signal using a spatial transform method, such as DCT, wavelet transform, or the like, so as to generate transform coefficients.

A quantization unit 630 quantizes the transform coefficients according to a predetermined quantization step (as the quantization step becomes larger, data loss or compression ratio becomes higher) so as to generate quantization coefficients. Quantization means a process that divides a DCT coefficient to be represented by an arbitrary real value into predetermined periods according to a quantization table, represents the divisions as discrete values, and matches the discrete values to the corresponding indexes. These quantization result values are referred to as the quantization coefficients.

Meanwhile, like the FGS layer encoder 600, the base layer encoder 500 includes a prediction unit 510, a transform unit 520, and a quantization unit 530 having the same functions. However, the prediction unit 510 cannot use intra base prediction or residual prediction.

An encoding unit 640 encodes the quantization coefficients with no loss and outputs an FGS layer bit stream. Similarly, an encoding unit 540 of the base layer outputs a base layer bit stream. As the lossless coding method, various lossless coding methods, such as Huffman coding, arithmetic coding, variable length coding, and the like, can be used.

A multiplexer 650 combines the FGS layer bit stream and the base layer bit stream and generates a bit stream to be transmitted to a video decoder stage.

The encoding unit 640 includes a transform coefficient classification unit 642, a reordering unit 644, and a coefficient coding unit 646.

The transform coefficient classification unit 642 classifies the transform coefficients of the blocks in the current layer to be encoded into the significant coefficients and the refinement coefficients. As described above, when the values of the transform coefficients of the blocks in the lower layer are zero, the transform coefficients of the blocks in the current layer are classified as the significant coefficients. Further, when the values of the transform coefficients are not zero, the transform coefficients are classified as the refinement coefficients.

The reordering unit 644 reorders the significant coefficients and the refinement coefficients according to the classifications. For example, the significant coefficients are ordered, and the refinement coefficients are ordered subsequently to the ordered significant coefficients. Alternatively, the refinement coefficients are ordered, and the significant coefficients are ordered subsequently to the ordered refinement coefficients.

The coefficient coding unit 646 codes the reordered significant coefficients and the refinement coefficients using the same coding method.

FIG. 9 is a block diagram of an apparatus for decoding a video signal of an FGS layer by reordering transform coefficients according to an embodiment of the invention.

The input bit stream is divided into an FGS layer bit stream and a base layer bit stream by a demultiplexer 760, and the divided FGS layer bit stream and base layer bit stream are supplied to the FGS layer decoder 800 and the base layer decoder 700, respectively.

The decoding unit 810 performs lossless decoding using a method corresponding to the encoding unit 640 so as to decompress the quantization coefficients. The decoding unit 810 includes a transform coefficient extraction unit 812, an inverse-ordering unit 814, and a coefficient decoding unit 816.

The transform coefficient extraction unit 812 parses the bit streams in the current layer to be decoded and extracts the transform coefficients. At this time, as described above, the bit streams are independently parsed without reference to the lower layer corresponding to the current layer. The inverse-ordering unit 814 orders the extracted transform coefficients again in an original sequence with reference to the blocks in the lower layer at the encoding stage. The coefficient decoding unit 816 decodes the inverse-ordered transform coefficients from the lower layer to the current layer.

An inverse quantization unit 820 inverse-quantizes the decompressed quantization coefficients by the quantization step used in the quantization unit 630. An inverse transform unit 830 inverse-transforms the inverse-quantization results using an inverse spatial transform method, such as inverse DCT transform, inverse wavelet transform, or the like.

An inverse prediction unit 840 calculates a prediction image obtained by the prediction unit 610 using the same method, and adds the calculated prediction image to the inverse-quantization results so as to decompress the video sequence.

Like the FGS layer decoder 800, the base layer decoder 700 includes a decoding unit 710, an inverse quantization unit 720, an inverse transform unit 730, and an inverse prediction unit 740 having the same functions.

The term “unit”, as the components shown in FIGS. 8 and 9, means, but is not limited to, a software or hardware component, such as a Field Programmable Gate Array (FPGA) or Application Specific Integrated Circuit (ASIC), which performs certain tasks. A component may advantageously be configured to reside on the addressable storage medium and configured to execute on one or more processors. Thus, a component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components may be combined into fewer components and units or further separated into additional components and units. In addition, the components may be implemented such that they execute one or more CPUs in a device.

Meanwhile, it will be understood by those skilled in the art that the scope of a method of encoding and decoding a video signal of an FGS layer by reordering transform coefficients according to the embodiment of the invention also includes a computer-readable recording medium having recorded thereon program codes for executing the above-described method on a computer.

Although the invention has been described in connection with exemplary embodiments of the invention, it will be apparent to those skilled in the art that various modifications and changes may be made thereto without departing from the scope and spirit of the invention. Therefore, it should be understood that the above embodiments are not limitative, but illustrative in all aspects. The scope of the invention is defined by the appended claims rather than by the description preceding them, and all changes and modifications that fall within metes and bounds of the claims, or equivalents of such metes and bounds are therefore intended to be embraced by the claims.

According to the embodiment of the invention, the following effects can be obtained.

Independent parsing becomes possible in a structure having a plurality of FGS layers, and thus computational complexity in a video compression technology can be reduced.

Further, in a decoding process of an FGS layer structure, independent parsing becomes possible.

Effects of the invention are not limited to those mentioned above, and other effects of the invention will be understood by those skilled in the art through the appended claims.

What is claimed is:

1. A method of encoding a video signal of an FGS layer by reordering transform coefficients that encodes transform coefficients of units of a portion of an image in an FGS layer constituting a video signal having a multilayer structure, the method comprising:
classifying transform coefficients of units of a portion of an image in a current layer to be encoded into significant coefficients and refinement coefficients,
reordering the significant coefficients and the refinement coefficients according to the classifications; and
coding the reordered significant coefficients and refinement coefficients.

2. The method of claim 1, wherein the units of a portion of an image are blocks.

3. The method of claim 1, wherein the units of a portion of an image are one of slices, frames and macro-blocks.

4. The method of claim 1, wherein the classifying comprises classifying the transform coefficients as the significant coefficients when the values of the transform coefficients of the blocks in the lower layer corresponding to the current layer are zero, and classifying the transform coefficients as the refinement coefficients when the values of the transform coefficients are not zero.

5. The method of claim 1, wherein the reordering comprises ordering all the significant coefficients and ordering all the refinement coefficients subsequent to the ordered significant coefficients.

6. The method of claim 1, wherein the reordering comprises ordering all the refinement coefficients and ordering all the significant coefficients subsequent to the ordered refinement coefficients.

7. The method of claim 1, wherein the coding comprises coding the significant coefficients and the refinement coefficients using the same coding method.

8. A computer-readable recording medium having recorded thereon program codes for executing the method according to claim 1 on a computer.

9. A method of decoding a video signal of an FGS layer by reordering transform coefficients that decodes transform coefficients of units of a portion of an image in an FGS layer constituting an encoded video signal having a multilayer structure, the method comprising:
parsing bit streams of a current layer to be decoded so as to extract transform coefficients;
inverse-ordering the extracted transform coefficients in an original sequence with reference to transform coefficients of units of a portion of an image in a lower layer; and
decoding the inverse-ordered transform coefficients.

10. The method of claim 9, wherein the units of a portion of an image are blocks.

11. The method of claim 9, wherein the units of a portion of an image are one of slices, frames and macro-blocks.

12. The method of claim 9, wherein the extracting of the transform coefficients comprises independently parsing the bit streams in the current layer without reference to the lower layer corresponding to the current layer so as to extract the transform coefficients.

13. The method of claim 9, wherein the inverse-ordering comprises ordering the significant coefficients first when the values of the transform coefficients of the units of a portion of an image in the lower layer are zero, and then ordering the refinement coefficients when the values of the transform coefficients of the units of a portion of an image are not zero.

14. The method of claim 9, wherein the inverse-ordering comprises ordering the refinement coefficients first when the values of the transform coefficients of the blocks in the lower layer are not zero, and then ordering the significant coefficients when the values of the transform coefficients are zero.

15. The method of claim 9, wherein the decoding is performed from the lower layer to the current layer.

16. A computer-readable recording medium having recorded thereon program codes for executing the method according to claim 9 on a computer.

17. An apparatus for encoding a video signal of an FGS layer by reordering transform coefficients that encodes transform coefficients of units of a portion of an image in an FGS layer constituting a video signal having a multilayer structure, the apparatus comprising:
a transform coefficient classification unit classifying transform coefficients of units of a portion of an image in a current layer to be encoded into significant coefficients and refinement coefficients;
a reordering unit reordering the significant coefficients and the refinement coefficients according to the classifications; and
a coefficient coding unit coding the reordered significant coefficients and refinement coefficients.

18. The apparatus of claim 17, wherein the units of a portion of an image are blocks.

19. The apparatus of claim 17, wherein the units of a portion of an image are one of slices, frames and macro-blocks.

20. The apparatus of claim 17, wherein the transform coefficient classification unit classifies the transform coefficients as the significant coefficients when the values of the transform coefficients of units of a portion of an image in a lower layer corresponding to the current layer are zero and classifies the transform coefficients of units of a portion of an image as the refinement coefficients when the values of the transform coefficients are not zero.

21. The apparatus of claim 17, wherein the reordering unit orders all the significant coefficients, and then orders all the refinement coefficients subsequent to the ordered significant coefficients.

22. The apparatus of claim 17, wherein the reordering unit orders all the refinement coefficients, and then orders the significant coefficients subsequent to the ordered refinement coefficients.

23. The apparatus of claim 17, wherein the coefficient coding unit codes the significant coefficients and the refinement coefficients using the same coding method.

24. An apparatus for decoding a video signal of an FGS layer by reordering transform coefficients that decodes transform coefficients of units of a portion of an image in an FGS layer constituting an encoded video signal having a multilayer structure, the apparatus comprising:
a transform coefficient extraction unit which parses bit streams in a current layer to be decoded so as to extract transform coefficients;
an inverse-ordering unit which inverse orders the extracted transform coefficients with reference to transform coefficients of blocks in the lower layer according to an original sequence; and
a coefficient decoding unit which decodes the inverse-ordered transform coefficients.

25. The apparatus of claim 24, wherein the units of a portion of an image are blocks.

26. The apparatus of claim 24, wherein the units of a portion of an image are one of slices, frames and macro-blocks.

27. The apparatus of claim 24, wherein the transform coefficient extraction unit independently parses the bit streams in the current layer without reference to the lower layer corresponding to the current layer so as to extract the transform coefficients.

28. The apparatus of claim 24, wherein the inverse-ordering unit orders the significant coefficients first when the values of the transform coefficients of the units of a portion of an image in the lower layer are zero, and then orders the refinement coefficients when the values of the transform coefficients of units of a portion of an image are not zero.

29. The apparatus of claim 24, wherein the inverse-ordering unit orders the refinement coefficients first when the values of the transform coefficients of the units of a portion of an image in the current layer are not zero, and then orders the significant coefficients when the values of the transform coefficients of units of a portion of an image are zero.

30. The apparatus of claim 24, wherein the coefficient decoding unit performs decoding from the lower layer to the current layer.
